(19) United States
(12) Patent Application Publication
(10) Pub. No.: US 2021/0013681 A1
(43) Pub. Date: Jan. 14, 2021

(54) CONNECTOR

(71) Applicant: SUMITOMO ELECTRIC INDUSTRIES, LTD., Osaka (JP)

(72) Inventors: Masaki SUZUKI, Tochigi (JP); Nobuyuki YAMAZAKI, Osaka (JP)

(21) Appl. No.: 17/040,716

(22) PCT Filed: Mar. 29, 2019
(86) PCT No.: PCT/JP2019/014006

§ 371 Date: Sep. 23, 2020

(30) Foreign Application Priority Data
Apr. 4, 2018 (JP) 2018-072582

(51) Int. Cl. H01R 13/6581; H01R 24/60

(52) U.S. Cl. CPC H01R 13/6581; H01R 24/60

(57) ABSTRACT

The connector includes a first metal shell having a front end (on the F side) for connection to an external member, a second metal shell disposed around a rear end (on the B side) of the first metal shell, and having a substrate housed therein, and a housing having the second metal shell and the rear end of the first metal shell contained therein, wherein the front end of the first metal shell is exposed outside the housing. The second metal shell has one or more recesses, on a same side as the first metal shell, recessed in a thickness direction of the second metal shell. The inner surface of a bottom portion of the one or more recesses is in surface-to-surface contact with the first metal shell.

### TECHNICAL FIELD

The disclosures herein relate to a connector.

The present application is based on and claims priority to Japanese patent application No. 2018-072582 filed on Apr. 4, 2018, and the entire contents of the Japanese patent application are hereby incorporated by reference.

### BACKGROUND ART

A publication discloses a connector attached to one end of a cable (Patent Document 1). The connector disclosed in Patent Document 1 includes a metal shell connected to a separate external member and a housing that covers the metal shell.

### RELATED-ART DOCUMENTS

### Patent Document

### [Patent Document 1] United States Patent Application Publication No. 2017/0040750

### SUMMARY OF THE INVENTION

A connector according to one aspect of the present disclosures includes

a first metal shell having a front end for connection to an external member,

a second metal shell disposed around a rear end of the first metal shell, and having a substrate housed therein, and

a housing having the second metal shell and the rear end of the first metal shell contained therein,

wherein the front end of the first metal shell is exposed outside the housing,

wherein the second metal shell has one or more recesses, on a same side as the first metal shell, recessed in a thickness direction of the second metal shell, and

wherein an inner surface of a bottom portion of the one or more recesses is in surface-to-surface contact with the first metal shell.

### BRIEF DESCRIPTION OF DRAWINGS

FIG. 1 is an axonometric view schematically illustrating a connector according to an embodiment of the present disclosures.

FIG. 2 is an axonometric view of a first metal shell and a second metal shell.

FIG. 3 is an axonometric view illustrating the first metal shell and the second metal shell that are in surface-to-surface contact with each other.

FIG. 4 is a schematic view illustrating the wrenching test method.

### MODE FOR CARRYING OUT THE INVENTION

### Problem to be Solved by the Present Disclosures

A connector is required such that a metal shell for connection to an external member is not readily disengaged from a housing when a bending force is applied to the metal shell in the thickness direction of the metal shell. In this regard, there is room for improvement with respect to a connector structure.

One of the objects of present disclosures is to provide a connector in which a metal shell is not readily disengaged from a housing when a bending force is applied to the metal shell in the thickness direction of the metal shell.

### Advantage of the Present Disclosures

According to the present disclosures, a connector is provided in which the first metal shell is not readily disengaged from the housing when a bending force is applied to the first metal shell in the thickness direction of the first metal shell.

### Outline of Embodiment of the Present Disclosures

Embodiments of the present disclosures will be described first.

(1) A connector according to one aspect of the present disclosures includes

a first metal shell having a front end for connection to an external member,

a second metal shell disposed around a rear end of the first metal shell, and having a substrate housed therein, and

a housing having the second metal shell and the rear end of the first metal shell contained therein,

wherein the front end of the first metal shell is exposed outside the housing,

wherein the second metal shell has one or more recesses, on a same side as the first metal shell, recessed in a thickness direction of the second metal shell, and

wherein an inner surface of a bottom portion of the one or more recesses is in surface-to-surface contact with the first metal shell.

The connector having the above-noted configuration is such that the inner surface of the bottom portion of the one or more recesses of the second metal shell is in surface-to-surface contact with the first metal shell, so that the first metal shell is not readily disengaged from the housing when a bending force is applied to the first metal shell in the thickness direction of the first metal shell.

(2) Further, the connector noted in (1) may be such that

the second metal shell has a hole that penetrates through the bottom portion.

According to this configuration, the presence of a hole allows confirmation to be made as to whether the end of the first metal shell is inserted past the hole when the first metal shell is attached to the second metal shell, thereby allowing confirmation to be made as to whether a predetermined length of the end of the first metal shell is inserted into the second metal shell. Moreover, the hole of the second metal shell allows the second metal shell to be aligned with the first metal shell.

(3) Further, the connector noted in (1) or (2) may be such that

an outer surface of the first metal shell includes a first flat face and a second flat face that are perpendicular to the thickness direction of the first metal shell, and the shape of a cross-section of the first metal shell extending parallel to the thickness direction and the width direction thereof has round corners, and

wherein the one or more recesses of the second metal shell include a first recess in surface-to-surface contact with the first flat face and a second recess in surface-to-surface contact with the second flat face.

According to this configuration, the first recess in surface-to-surface contact with the first flat face and the second recess in surface-to-surface contact with the second flat face are provided so that the first metal shell is not readily disengaged from the housing when a bending force is applied in the thickness direction of the first metal shell.

### Details of Embodiments of the Present Disclosures

In the following, an example of a connector according to embodiments of the present disclosures will be described in detail with reference to accompanying drawings. The present invention is not limited to those examples, and is intended to include any variations and modifications which may be made without departing from the scope of the claims and from the scope warranted for equivalents of the claimed scope.

### Embodiment

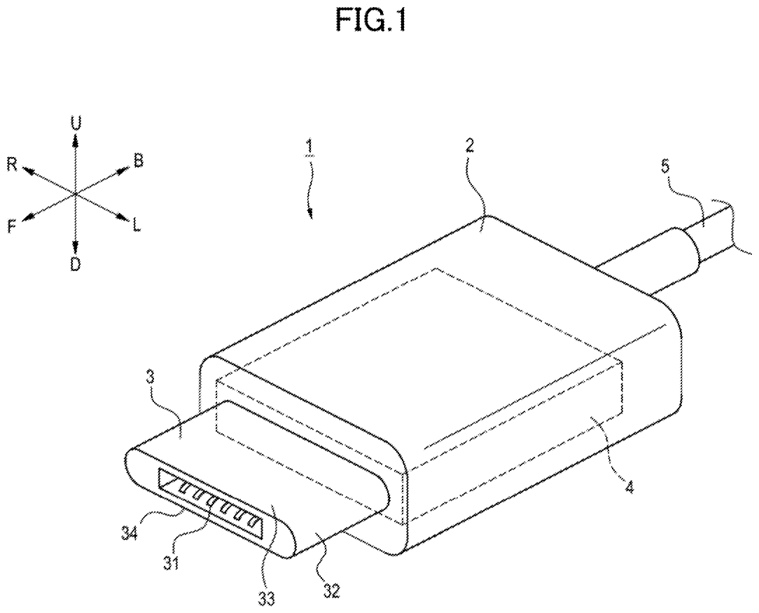

FIG. 1 is an axonometric view schematically illustrating a connector 1 according to an embodiment of the present disclosures. The connector 1 may be used as a cable connector for connection between electronic devices (which are an example of an external member, not shown), for example. U, D, F, B, R, and L illustrated in FIG. 1 refer to directions relative to the connector 1. U denotes an upward direction, D denoting a downward direction, F denoting a frontward direction, B denoting a rearward direction, R denoting a rightward direction, and L denoting a leftward direction.

As illustrated in FIG. 1, the connector 1 includes a housing 2, a first metal shell 3, and a second metal shell 4 contained in the housing 2. The connector 1 is connected to a cable 5 at the rearward B side.

### (Housing)

The housing 2 is a case containing the end of the first metal shell 3 on the rearward B side and the entirety of the second metal shell 4. The housing 2 has a flattened tubular shape that is longer in the RL direction than in the UD direction. The cross-section extending parallel to the UD direction and the RL direction of the housing 2 has an oblong rectangular shape having rounded corners. The housing 2 may be made of resin, for example.

### (First Metal Shell)

The first metal shell 3 is a plug portion of the connector 1. The first metal shell 3 includes contact pins 31 for electrical connection to the receptacle of an electronic device (not shown) on the frontward F side exposed outside the housing 2.

The first metal shell 3 is a metallic case with a flattened tubular shape that is longer in the RL direction than in the UD direction. The outer surface of the first metal shell 3 is shaped such that the shape of a cross-section of the first metal shell 3 extending parallel to the thickness direction (i.e., the UD direction in FIG. 1) and the width direction (i.e., the RL direction in FIG. 1) has round corners 32. Here, the shape having round corners includes a convex curved-line shape, an oval shape, a generally rectangular shape, a polygonal shape with rounded corners, and the like.

The first metal shell 3 has an upper face 33 (which is an example of the first flat face) and a lower face 34 (which is an example of the second flat face). The upper face 33 and the lower face 34 are planes perpendicular to the thickness direction of the first metal shell 3.

### (Second Metal Shell)

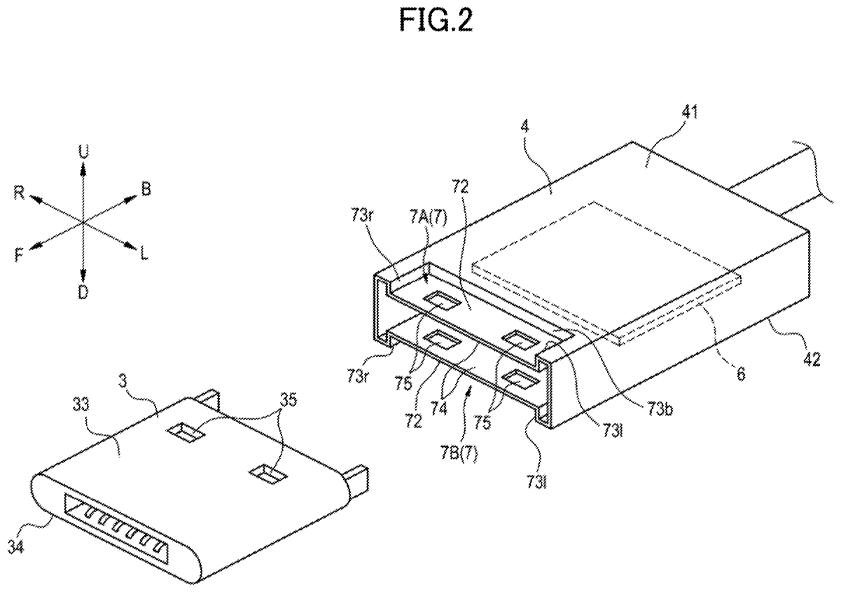

FIG. 2 is an axonometric view of the first metal shell 3 and the second metal shell 4. As illustrated in FIG. 1 and FIG. 2, the second metal shell 4 is a metallic case with a cuboid shape that is longer in the RL direction than in the UD direction. The cross-section of the second metal shell 4 extending parallel to the UD direction and the RL direction has an outer shape that is generally rectangular. The second metal shell 4 contains therein a substrate 6 that is connected to the frontward F side of the cable 5.

The second metal shell 4 has an upper face 41 and a lower face 42. The upper face 41 and the lower face 42 of the second metal shell 4 has recesses 7 situated on the frontward F side. The upper face 41 has a first recess 7A recessed in the upper face 41 toward the downward D side. The lower face 42 has a second recess 7B recessed in the lower face 42 toward the upward U side. The configuration as appears when viewing the first recess 7A from the U side and the configuration as appears when viewing the second recess 7B from the D side are substantially the same, In the following, thus, the configuration of the first recess 7A will be described, and a description of the second recess 7B will be omitted, with the same reference numerals as those of the first recess 7A being assigned thereto.

The first recess 7A includes a bottom portion 72, a sidewall 73r standing on the R-side edge of the bottom portion 72 toward the U side, and a sidewall 73b standing on the B-side edge of the bottom portion 72 toward the U side, and a sidewall 73l standing on the L-side edge of the bottom portion 72 toward the U side. The inner surface 74 of the bottom portion 72 of the first recess 7A is planar. The size of the rectangular shape of the bottom portion 72 may be such that the two sides of the bottom portion 72 extending in the FB direction are 1 mm and the two sides of the bottom portion 72 extending in the RL direction are 4 mm, for example.

(Surface-to-Surface Contact between First Metal Shell and Second Metal Shell)

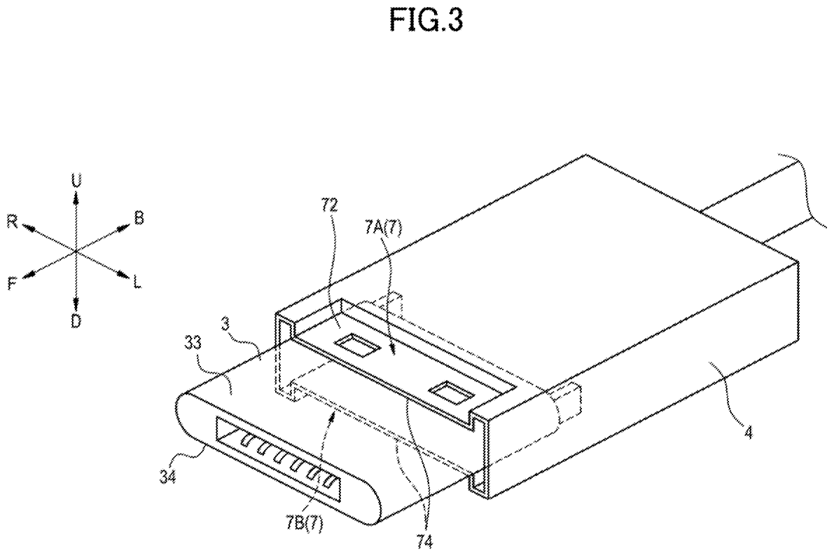

FIG. 3 is an axonometric view illustrating the first metal shell 3 and the second metal shell 4 that are in surface-to-surface contact with each other. As illustrated in FIG. 3, the first metal shell 3 is mounted to the second metal shell 4, with the upper face 33 being in surface-to-surface contact with the inner surface 74 of the bottom portion 72 of the first recess 7A of the second metal shell 4.

The lower face 34 of the first metal shell 3 is also attached to the second metal shell 4 such as to be in surface-to-surface contact with the inner surface 74 of the bottom portion 72 of the second recess 7B of the second metal shell 4 as in the case of the upper face 33.

### (Alignment Between First Metal Shell and Second Metal Shell)

The connector 1 is configured to facilitate alignment of the first metal shell 3 with the second metal shell 4 when establishing surface-to-surface contact between the first metal shell 3 and the second metal shell 4.

As illustrated in FIG. 2, the second metal shell 4 has holes 75. Two holes 75 are formed through the bottom portion 72 of the first recess 7A. The holes 75 are through holes that penetrate through the bottom portion 72 of the first recess 7A, and are a rectangular shape that is longer in the RL direction than in the FB direction as viewed from the upward U side. The bottom portion 72 of the second recess 7B has the same number of holes 75 having substantially the same shape as the holes 75 of the first recess 7A. The provision of the holes 75 allows the second metal shell 4 to be aligned with the first metal shell 3. For example, confirmation may be made as to whether the end of the upper face 33 of the first metal shell 3 on the rearward B side goes past the holes 75 by viewing the holes 75 of the first recess 7A from the upward U side. This allows confirmation to be made as to whether a predetermined length of the upper face 33 in the FB direction has been inserted into the second metal shell 4. Further, the holes 75 formed through the bottom portion 72 of the second metal shell 4 allows the second metal shell 4 to be aligned with the first metal shell 3. This alignment may be made, for example, by soldering the first metal shell 3 and the second metal shell 4 by utilizing the holes 75 of the second metal shell. 4 while keeping the upper face 33 of the first metal shell 3 attached to the inner surface 74 of the bottom portion 72 of the second metal shell 4.

In the connector 1, further, the first metal shell 3 may be configured to facilitate alignment of the first metal shell 3 with the second metal shell 4. As an example, the first metal shell 3 may have marks as illustrated in FIGS. 2 and 3. The marks may be comprised of two holes 35 formed in each of the upper face 33 and the lower face 34 of the first metal shell 3 at the positions corresponding to the holes 75 of the second metal shell 4.

Here, the marks may alternatively be 2-dimensional signs such as lines, patterns, letters, or the like. The provision of such marks allows the first metal shell 3 to be slid into the second metal shell 4, with the upper face 33 and the lower face 34 of the first metal shell 3 being in contact with the upper face 41 and the lower face 42 of the second metal shell 4, respectively.

The marks are not limited to the above-noted examples. The marks suffice as long as they enable alignment of the first metal shell with the second metal shell, and may be designed to have any 2-dimensional or flat shape. The configuration may alternatively be such that the marks are provided on only either one of the upper face and the lower face. The number of marks is not limited to four as in the illustrated example, and may be any number that is greater than or equal to one.

For example, the marks of the first metal shell 3 may be formed with lines tracing the outline of the holes 75 of the second metal shell 4, and may be equal in number to the holes 75. In such a case, alignment of the first metal shell 3 with the second metal shell 4 is made by achieving a condition in which the outlines of the holes 75 of the second metal shell 4 coincide with the lines of the marks such as to make the lines of the marks invisible through the holes 75 of the second metal shell 4.

As may be noted, a connector is required such that a metal shell for connection to an external member is not readily disengaged from a housing when a bending force is applied to the metal shell in the thickness direction of the metal shell. There is thus room for improvement with respect to a connector structure.

In consideration of this, the connector 1 of the present embodiment is configured as described above such that the inner surface 74 of the bottom portion 72 of the recess 7 of the second metal shell 4 is in surface-to-surface contact with the first metal shell 3. With this configuration, the entirety of the area achieving the surface-to-surface contact receives a bending force when the bending force is applied to the first metal shell 3 in the thickness direction of the first metal shell 3, which prevents pressure from being locally concentrated. Bending of the first metal shell 3 or the second metal shell 4 is thus prevented. This makes the first metal shell 3 unlikely to be disengaged from the second metal shell 4, thereby providing the connector 1 in which the first metal shell 3 is not likely to disengage from the housing 2.

In the connector 1 of the present embodiment, further, the presence of the holes 75 allows confirmation to be made as to whether the end of the first metal shell 3 is inserted past the holes 75 when the first metal shell 3 is attached to the second metal shell 4, thereby allowing confirmation to be made as to whether a predetermined length of the end of the first metal shell 3 on the rearward B side is inserted into the second metal shell 4. Moreover, the holes 75 of the second metal shell 4 allow the second metal shell 4 to be aligned with the first metal shell 3.

Further, the provision of the holes 75 and the marks in the connector 1 allows the second metal shell 4 to be more easily aligned with the first metal shell 3.

The connector 1 of the present embodiment has the first recess 7A in surface-to-surface contact with the upper face 33 and the second recess 7B in surface-to-surface contact with the lower face 34. With this configuration, at least one of the two areas each achieving surface-to-surface contact is capable of receiving a bending force, regardless of which one of the upper face 33 and the lower face 34 is the side from which the bending force is applied. It thus becomes more certain that the first metal shell 3 does not readily disengage from the second metal shell 4, thereby providing the connector 1 in which the first metal shell 3 is less likely to disengage from the housing 2.

The present disclosures are not limited to the above-described embodiments, and variations and modifications may be made in any manner as appropriate. The material, shape, dimension, value, configuration, number, placement position, and the like of each constituent element of the noted embodiments are not limited, and are selected as desired as long as they are conducive to achieving the present disclosures.

The exterior shape of the second metal shell 4 is not limited to the above-described shape. It suffices for the shape of the second metal shell 4 to have a flat face that comes in surface-to-surface contact with the first metal shell 3. For example, the second metal shell 4 may have exterior corners that are rounded similarly to the corners 32 of the first metal shell 3. The second metal shell 4 may be integrally molded, or may be formed by combining a plurality of plate members.

The above-described embodiments have been directed to an example in which both the upper face 33 and the lower face 34 of the first metal shell 3 are placed in surface-to-surface contact with the inner surfaces 74 of the second metal shell 4. It should be noted that the configuration of surface-to-surface contact is not limited to this rioted example. It suffices for the first metal shell 3 to have at least one of the upper face 33 and the lower face 34 placed in surface-to-surface contact with the inner surface 74 of the second metal shell 4.

In the following, an example embodiment of the present disclosures will be described. Connectors of an example embodiment and of a comparative example were prepared, and the wrenching test was performed

### Example Embodiment

The configuration of a connector 1 of the example embodiment was the same as the configuration of the embodiment illustrated in FIG. 1 through FIG. 3, and was implemented as follows.

The second metal shell 4 was disposed on the rear end side (on the B side) of the first metal shell 3, followed by securely connecting both with each other. The rear end of the first metal shell 3 and the second metal shell 4 were placed inside the housing 2, The second metal shell 4 was configured such that the upper face 41 and the lower face 42 on the front end side (on the F side) were each provided with the recess 7 having the bottom portion 72 whose two sides extending in the FB direction were 1 mm and whose two sides extending in the RL direction were 4 mm, thereby being provided with the first recess 7A and the second recess 7B, respectively. The inner surface 74 of the bottom portion 72 of the first recess 7A was placed in surface-to-surface contact with the upper face 33 of the first metal shell 3. The inner surface 74 of the bottom portion 72 of the second recess 7B was placed in surface-to-surface contact with the lower face 34 of the first metal shell 3. Thereby the connector 1 was prepared.

### Comparative Example

The comparative example was such that the second metal shell 4 was not provided with a recess. Anything apart from that was substantially the same as the example embodiment.

### (Wrenching Test)

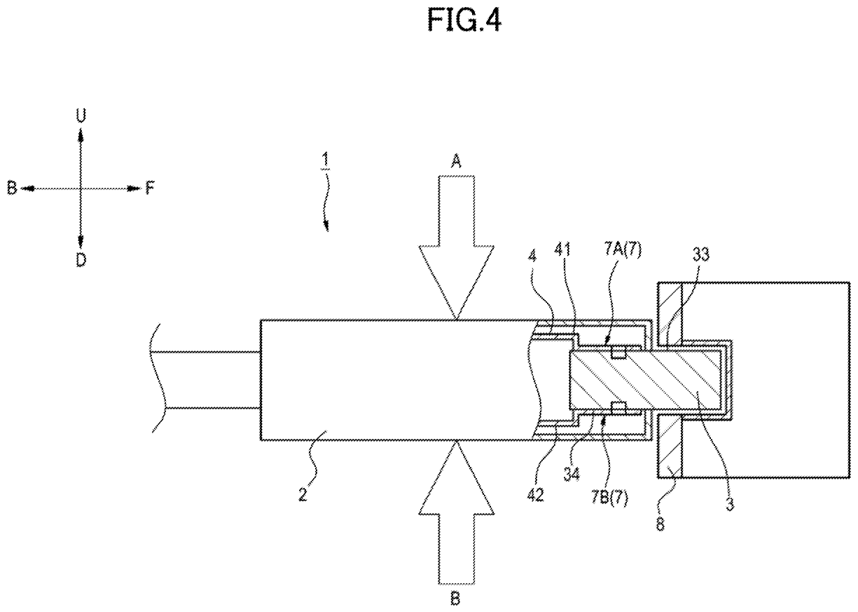

The wrenching test was conducted with respect to the example embodiment and the comparative example noted above, thereby evaluating whether the first metal shell of the connector disengages from the housing. In the wrenching test, as illustrated in FIG. 4, a fixture 8 for fixedly gripping the upper face and lower face of the first metal shell in the UD direction was used to secure the first metal shell of the example embodiment and the first metal shell of the comparative example. Pressure was applied at 50 N for 10 seconds in the direction from the upward U side toward the downward D side (i.e., in the direction indicated by an arrow A in FIG. 4) to the position that marked a predetermined distance from the front end (on the F side) of the housing toward the rear end side (on the B side) of the housing, The predetermined distance was 15.0 mm as an example. Further, pressure was applied to the same position at 50 N for 10 seconds in the direction from the downward D side toward the upward U side (i.e., in the direction indicated by an arrow B in FIG. 4). Connectors were regarded as passing the test when the first metal shell did not disengage from the housing during either the application of pressure in the arrow-A direction or the application of pressure in the arrow-B direction.

### (Test Result)

In the case of the example embodiment, the first metal shell did not disengage from the housing, thereby passing the test. In contrast, in the case of the comparative example, the front end of the second metal shell came in line contact with the first metal shell along a line extending in the RL direction upon application of pressure. This line contact caused pressure to be more locally concentrated, thereby causing deformation of the front end of the second metal shell. The first metal shell disengaged from the second metal shell, with the result thus failing the test.

As described above, it was confirmed that the first metal shell of the example embodiment was less likely to disengage from the housing than the first metal shell of the comparative example.

### DESCRIPTION OF REFERENCE SYMBOLS

1 connector
2 housing
3 first metal shell
4 second metal shell
5 cable
6 substrate
7 recess
7A first recess
7B second recess
8 fixture
31 contact pin
32 corner
33 upper face
34 lower face
35 hole
41 upper face
42 lower face
72 bottom portion
73b sidewall
73l sidewall
73r sidewall
74 inner surface
75 hole
B rearward direction
D downward direction
F frontward direction
U upward direction

1. A connector, comprising:
a first metal shell having a front end for connection to an external member;
a second metal shell disposed around a rear end of the first metal shell, and having a substrate contained therein; and
a housing having the second metal shell and the rear end of the first metal shell contained therein,
wherein the front end of the first metal shell is exposed outside the housing,
wherein the second metal shell has one or more recesses, on a same side as the first metal shell, recessed in a thickness direction of the second metal shell, and
wherein an inner surface of a bottom portion of the one or more recesses is in surface-to-surface contact with the first metal shell.

2. The connector as claimed in claim 1 wherein the second metal shell has a hole that penetrates through the bottom portion.

3. The connector as claimed in claim 1 wherein an outer surface of the first metal shell includes a first flat face and a second flat face that are perpendicular to a thickness direction of the first metal shell, and a shape of a cross-section of the first metal shell extending parallel to the thickness direction and a width direction thereof has round corners, and
wherein the one or more recesses of the second metal shell include a first recess in surface-to-surface contact with the first flat face and a second recess in surface-to-surface contact with the second flat face.

4. The connector as claimed in claim 2 wherein an outer surface of the first metal shell includes a first flat face and a second flat face that are perpendicular to a thickness direction of the first metal shell, and a shape of a cross-section of the first metal shell extending parallel to the thickness direction and a width direction thereof has round corners, and
wherein the one or more recesses of the second metal shell include a first recess in surface-to-surface contact with the first flat face and a second recess in surface-to-surface contact with the second flat face.
